(19) United States
(12) Patent Application Publication
(10) Pub. No.: US 2019/0112453 A1
(43) Pub. Date: Apr. 18, 2019

(54) PROTECTIVE NEGATIVE ELECTRODE FOR LITHIUM METAL BATTERY AND LITHIUM METAL BATTERY COMPRISING SAME

(71) Applicant: SAMSUNG SDI CO., LTD., Yongin-si, Gyeonggi-do (KR)

(72) Inventors: Jinkyu KIM, Yongin-si, Gyeonggi-do (KR); Jungmin SONG, Yongin-si, Gyeonggi-do (KR); Sangkyun IM, Yongin-si, Gyeonggi-do (KR)

(21) Appl. No.: 16/099,821

(22) PCT Filed: May 11, 2017
(86) PCT No.: PCT/KR2017/004892

§ 371 Date: Nov. 8, 2018

(30) Foreign Application Priority Data
May 12, 2016 (KR) 10-2016-0058180

(51) Int. Cl. C08K 9/06; C08K 5/544; C08K 5/02; C08K 5/41; C08K 5/315; C09C 1/40; H01M 10/052; H01M 4/62; H01M 4/134; H01M 4/38

(52) U.S. Cl. CPC C08K 9/06; C08K 5/5442; C08K 5/02; C08K 5/41; H01M 4/382; C09C 1/407; H01M 10/052; H01M 4/628; H01M 4/134; C08K 5/315

(57) ABSTRACT

Provided are a protective negative electrode for a lithium metal battery, which includes a lithium metal negative electrode, and a protective film disposed on the lithium metal negative electrode and including a filler bound with a siloxane functional group and a polymer; and a lithium metal battery including the same.

### TECHNICAL FIELD

The present disclosure relates to a protective negative electrode for a lithium metal battery and a lithium metal battery including the same.

### BACKGROUND ART

Lithium secondary batteries are high-performance secondary batteries having the highest energy density among currently commercialized secondary batteries and may be used in various fields such as electric vehicles.

As a negative electrode of the lithium secondary battery, a lithium metal thin film may be used. When the lithium metal thin film is used as the negative electrode, reactivity with a liquid electrolyte during charging and discharging is high due to high reactivity of lithium. In addition, dendrites are formed on a lithium negative electrode thin film, so that the lifetime and stability of the lithium secondary battery employing the lithium metal thin film may be deteriorated, and thus, improvement therefor is required.

### DESCRIPTION OF EMBODIMENTS

### Technical Problem

Provided is a protective negative electrode for a lithium metal battery.

Also, provided is a lithium metal battery with improved cell performance including a negative electrode protective film.

### Solution to Problem

According to an aspect of the present disclosure, there is provided a protective negative electrode for a lithium metal battery including a lithium metal negative electrode; and a protective film disposed on the lithium metal negative electrode and including a filler bound with a functional group represented by the following Formula 1 and a polymer.

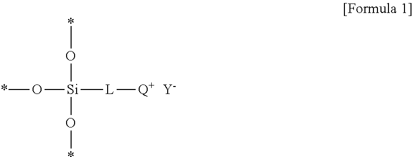

In Formula 1, L is a substituted or unsubstituted C1 to C10 alkyl group,

Q⁺ is a quaternary ammonium cation,

Y⁻ is a monovalent anion, and

* represents a site where the functional group of Formula 1 is bound to a surface of the filler.

According to another aspect of the present disclosure, there is provided a lithium metal battery including the protective negative electrode, a positive electrode, and an electrolyte interposed therebetween.

### Advantageous Effects of Disclosure

By using the lithium negative electrode protective film for the lithium metal battery according to an embodiment, it is possible to effectively inhibit the growth of lithium dendrite on the surface of the lithium metal negative electrode and increase the lithium electrodeposition density. As a result, it is possible to manufacture a lithium metal battery with an improved life span.

### BRIEF DESCRIPTION OF DRAWINGS

FIG. 1 schematically illustrates a structure of a lithium metal battery according to an exemplary embodiment.

FIG. 2 is a diagram for describing a manufacturing process of a surface-modified filer, according to an exemplary embodiment.

FIGS. 3 and 4 are electron scanning micrographs of a lithium metal negative electrode protective film in lithium metal batteries manufactured according to Example 1 and Comparative Example 1, respectively.

FIG. 5 illustrates lifetime characteristics of the lithium metal batteries manufactured according to Example 1 and Comparative Example 1.

FIG. 6 illustrates lifetime characteristics of lithium metal batteries manufactured according to Comparative Examples 3 and 4.

FIG. 7 illustrates a voltage profile of a lithium metal battery manufactured according to Example 2.

### BEST MODE

According to an aspect of the present disclosure, there is provided a protective negative electrode for a lithium metal battery including a lithium metal negative electrode; and a protective film which is disposed on the lithium metal negative electrode and includes a filler bound with a functional group represented by the following Formula 1 and a polymer.

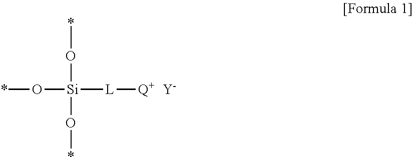

In Formula 1, L is a substituted or unsubstituted C1 to C10 alkyl group,

Q⁺ is a quaternary ammonium cation,

Y⁻ is a monovalent anion, and

* represents a site where the functional group of Formula 1 is bound to the surface of the filler.

According to another aspect of the present disclosure, there is provided a lithium metal battery including the protective negative electrode, a positive electrode, and an electrolyte interposed therebetween.

### Mode of Disclosure

Hereinafter, a protective negative electrode for a lithium metal battery, a lithium metal battery including the same, and a method of manufacturing the same will be described in more detail with reference to the accompanying drawings.

According to an aspect of the present disclosure, there is provided a protective negative electrode for a lithium metal battery including a lithium metal negative electrode; and

a protective film which is disposed on the lithium metal negative electrode and includes a filler bound with a functional group represented by the following Formula 1 and a polymer.

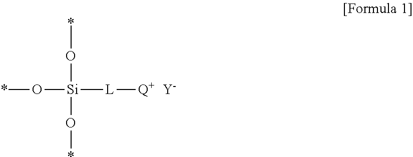

In Formula 1, L is a substituted or unsubstituted C1 to C10 alkyl group,

Q is a quaternary ammonium cation,

Y is an anion, and

* represents a site where the functional group of Formula 1 is bound to the surface of the filler.

In Formula 1 above, L includes a methylene group, an ethylene group, a propylene group, and a butylene group.

Q is —N⁺(R₁)(R₂)(R₃)(R₄). R₁, R₂, R₃ and R₄ independently represent a substituted or unsubstituted C1 to C10 alkyl group or a substituted or unsubstituted C6 to C10 aryl groups, and at least two of R₁, R₂, R₃ and R₄ may form a ring. Here, the ring may be a C3-C8 carbon ring or a C2-C8 hetero ring.

In the lithium metal battery having the lithium metal negative electrode, while lithium dendrite is grown on the surface of the lithium metal negative electrode during driving of the battery, the lithium dendrite contacts the positive electrode, resulting in a problem that the battery operation is stopped. In order to prevent the lithium dendrite from being locally grown and disposed on the surface of the lithium metal negative electrode, a method of forming a protective film including a filler on the lithium metal negative electrode has been proposed.

However, according to the method, the interfacial resistance between the lithium metal negative electrode and the protective film increases, and the mobility of lithium ions required for driving the lithium metal battery is remarkably lowered, thereby causing problems in the cell operation.

The present disclosure provides a protective negative electrode for a lithium metal battery including a protective film including a surface-modified filler in order to solve the aforementioned problems. When such a protective negative electrode is used, it is possible to improve the performance of the battery by suppressing the growth of lithium dendrite generated during driving of the battery and preventing dendrite from being locally formed to grow uniformly the dendrite. The protective negative electrode is good in migration of lithium ions on the lithium metal negative electrode, and has small resistance and good mechanical strength.

The average particle diameter of the filler may be 1 μm or less, for example, 500 nm or less, specifically 10 to 500 nm. When the average particle diameter of the filler is in the above range, it is possible to manufacture a protective film which is good in film forming property and good in mechanical properties without lowering ionic conductivity.

In Formula 1 above, -L-Q is at least one selected from the group represented by the following Chemical Formulas 2 to 8.

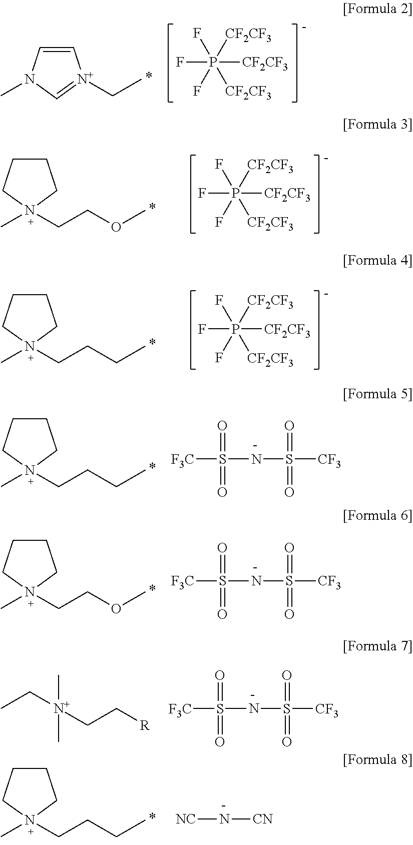

In Chemical Formulas 2 to 8 above, * represents a site bound to Si.

Since the protective film according to an exemplary embodiment is very good in strength and flexibility by including the above-mentioned composition, it is possible to effectively suppress the growth of lithium dendrites on the surface of the lithium metal negative electrode. In addition, an ion conductive film having high ionic conductivity is formed between the lithium metal and the protective film, so that the resistance in the interface between the lithium metal and the protective film is low.

In the lithium metal battery according to the exemplary embodiment, a protective film containing a metal salt having a reduction potential smaller than a standard reduction potential of lithium and an ion conductive film forming agent at the same time is employed, thereby increasing the electrodeposition density of the lithium metal battery, increasing mobility of lithium ions, and reducing the interfacial resistance between the lithium negative electrode and the protective film. As a result, it is possible to manufacture a lithium metal battery with an improved lifetime.

In the lithium metal battery, the electrodeposition density of the lithium metal negative electrode is 0.2 to 0.3 g/cc.

A method for manufacturing the surface-modified filler according to the exemplary embodiment will be described as follows. The method for manufacturing the surface-modified filler will be described with reference to a method for manufacturing a filler represented by the following Formula 12.

As illustrated in FIG. 2, a filler 100 having a functional group that forms a siloxane group on the surface by reacting with a first surface modifier selected from a silane compound, a siloxane compound, a silazane compound, and a silanol compound is manufactured. Subsequently, the filler 100 having the functional group that forms the siloxane group on the surface reacts with a quaternary ammonium compound which is a second surface modifier to obtain a surface-modified filler 102 bound with a functional group 101 of Formula 1.

The protective negative electrode according to the exemplary embodiment contains a protective film containing the surface-modified filler described above. The protective film containing the filler is improved in strength and plays a role of blocking the dendrite of lithium itself, and the surface-modified filler has a siloxane (Si—O—) group on the surface of the filler such as aluminum oxide as illustrated in FIG. 2, so that a uniform film is formed when the lithium ions are electrodeposited. In addition, quaternary ammonium cationic and anionic groups are present on the siloxane group to effectively prevent lithium dendrite from being locally grown and formed on the surface of the lithium metal negative electrode, thereby preventing a short-circuit of the battery.

The thickness of a surface-modified layer in the surface-modified filler is, for example, 10 to 100 nm. When such a surface-modified layer thickness is provided, the lithium dendrite suppressing effect is good.

The silane compound may be an organosilane represented by the following Formula 13.

Si(OR₅)₄₋ₙR₆ [Formula 13]

In Formula 13, R₅ and R₆ are each independently hydrogen, a C1-C10 alkyl group, a C2-C10 alkenyl group, an amine group, or a C6-C10 aryl group, and n is an integer of 4 or less.

Examples of the alkyl group include methyl, ethyl, propyl, butyl, pentyl, isopropyl, isobutyl, tertbutyl, and the like. Examples of the alkenyl group include a vinyl group, an allyl group, and the like. Examples of the aryl group include phenyl and the like.

The silane-based compound may use, for example, dimethyldimethoxysilane, dimethyldiethoxysilane, methyltrimethoxysilane, vinyltrimethoxysilane, phenyltrimethoxysilane, tetraethoxysilane, dimethyldichlorosilane, 3-aminopropyl triethoxy silane and the like.

The siloxane-based compound may be a compound represented by the following Formula 14.

R₇R₈SiO [Formula 14]

In Formula 14, R₇ and R₈ are each independently hydrogen, a C1-C10 alkyl group, a C2-C10 alkenyl group, an amine group or a C6-C10 aryl group.

As specific examples of the siloxane-based compound, polydimethylsiloxane, polydiethylsiloxane, octamethylcyclotetrasiloxane, and the like may be used.

The silazane-based compound may be a compound represented by the following Formula 15.

Si₂NR₁R₂R₃R₄R₅R₆R₇ [Formula 15]

In Formula 15, R₁ and R₇ are each independently hydrogen, a C1-C10 alkyl group, a C2-C10 alkenyl group, an amine group or a C6-C10 aryl group.

Examples of the silazane-based compound may include hexamethyldisilazane, hexamethylcyclotrisilazane, heptamethyldisilazane, and the like.

The silanol-based compound may be a compound represented by the following Formula 16.

SiOHR₁R₂R₃ [Formula 16]

In Formula 16, R₁ and R₃ are each independently hydrogen, a C1-C10 alkyl group, a C2-C10 alkenyl group, an amine group or a C6-C10 aryl group.

Examples of the silazane-based compound may include trimethylsilanol, triethylsilanol, triphenylsilanol, t-butyldimethylsilanol, and the like.

The quaternary ammonium compound uses, for example, one selected from compounds represented by the following Chemical Formulas 2a to 8a.

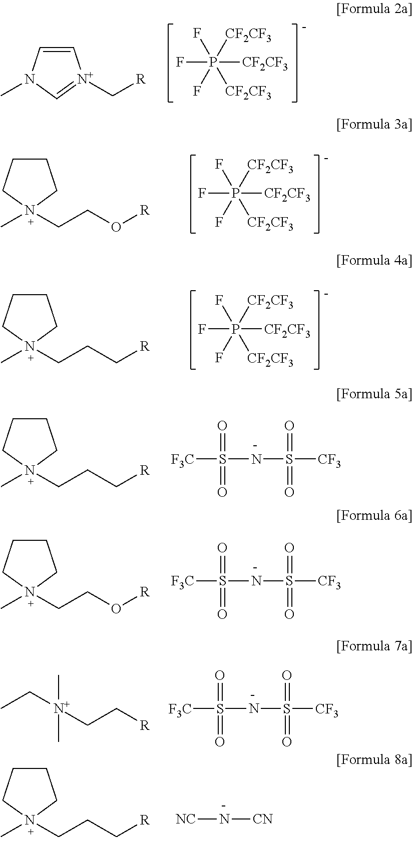

In Chemical Formulas 2a to 8a, R is a C1 to C5 alkyl group.

The content of the quaternary ammonium compound is 20 to 40 parts by weight based on 100 parts by weight of the filler. When the content of the quaternary ammonium compound is in the above range, the effect of suppressing the growth and formation of lithium dendrites on the surface of the lithium metal negative electrode is good.

The filler is at least one selected from SiO₂, TiO₂, ZnO, Al₂O₃, BaTiO₃, and silsesquioxane having a cage structure.

In the filler bound with the functional group represented by Formula 1 above, at least one filler selected from SiO₂, TiO₂, ZnO, Al₂O₃, BaTiO₃, and silsesquioxane having a cage structure and at least one selected from functional groups represented by the following Chemical Formulas 9 to 11 are bound onto the surface of the filler.

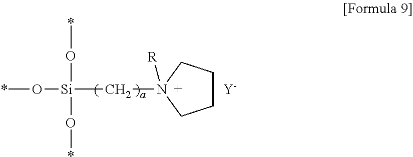

In Formula 9, a is an integer of 1 to 5,

R is hydrogen or a C1-C5 alkyl group, and

Y is PF₆, BF₄, SbF₆, AsF₆, ClO₄, CF₃SO₃, (CF₃SO₂)₂N, C₄F₉SO₃, AlO₂, alCl₄, (NC)N, PF₃(CF₂CF₃)₃, (FSO₂)₂N, (CF₃SO₂)₂N, (C₂F₅SO₂)₂N, (C₂F₅SO₂)(CF₃SO₂)N or (FSO₂)(CF₃SO₂)N,

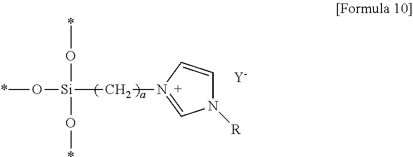

R is hydrogen or a C1-C5 alkyl group, and

Y is PF₆, BF₄, SbF₆, AsF₆, ClO₄, CF₃SO₃, (CF₃SO₂)₂N, C₄F₉SO₃, AlO₂, alCl₄, (NC)N, PF₃(CF₂CF₃)₃, (FSO₂)₂N, (CF₃SO₂)₂N, (C₂F₅SO₂)₂N, (C₂F₅SO₂)(CF₃SO₂)N or (FSO₂)(CF₃SO₂)N,

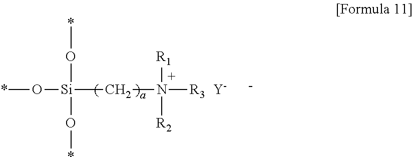

In Formula 11, a is an integer of 1 to 5, Y is PF₆, BF₄, SbF₆, AsF₆, ClO₄, CF₃SO₃, (CF₃SO₂)₂N, C₄F₉SO₃, AlO₂, AlCl₄, (NC)N, PF₃(CF₂CF₃)₃, (FSO₂)₂N, (CF₃SO₂)₂N, (C₂F₅SO₂)₂N, (C₂F₅SO₂)(CF₃SO₂)N or (FSO₂)(CF₃SO₂)N, and

R₁ to R₃ are independently hydrogen or a C1 to C10 alkyl group.

In the filler bound with the functional group represented by Formula 1 above, for example, at least one selected from functional groups represented by the following Chemical Formulas is bound onto SiO₂, or TiO₂ and the surface of SiO₂ or TiO₂.

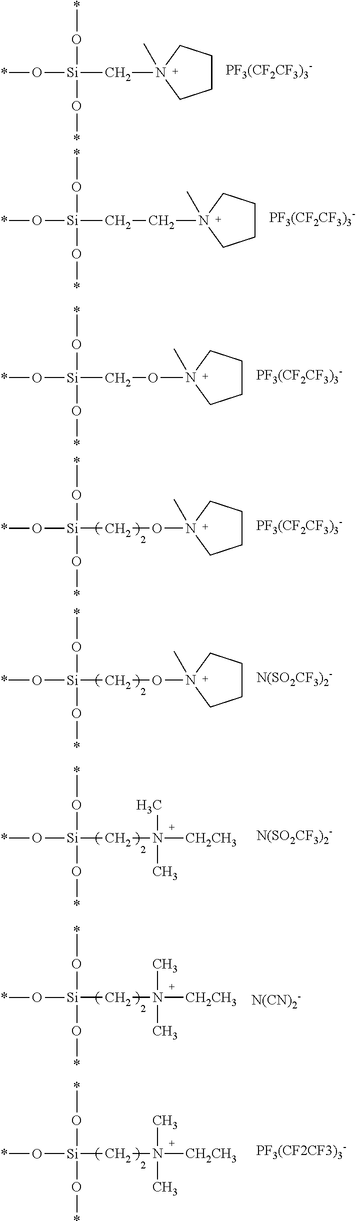

The silsesquioxane having the cage structure may be, for example, polyhedral oligomeric silsesquioxane (POSS). 8 or less, for example, 6 or 8 silicons are present in the POSS. The silsesquioxane having the cage structure may be a compound represented by the following Formula 17.

SiₖO_{1.5k}(R₁)ₐ(R₂)_{b}(R₃)_{c} [Formula 17]

In Formula 17 above, R₁, R₂, and R₃ may be each independently hydrogen, a substituted or unsubstituted C1-C30 alkyl group, a substituted or unsubstituted C1-C30 alkoxy group, a substituted or unsubstituted C2-C30 alkenyl group, a substituted or unsubstituted C2-C30 alkynyl group, a substituted or unsubstituted C6-C30 aryl group, a substituted or unsubstituted C6-C30 aryloxy group, a substituted or unsubstituted C2-C30 heteroaryl group, a substituted or unsubstituted C4-C30 carbon ring group, or a silicon-containing functional group.

In Formula 17 above, k=a+b+c and 6≤k≤20.

The polymer contained in the protective film may use, for example, at least one selected from a vinylidene fluoride hexafluoropropylene copolymer, polyvinylidene fluoride, polymethylmethacrylate, carboxymethylcellulose, styrene-butadiene rubber, polyacrylonitrile, and polytetrafluoro ethylene.

The protective film may further include a lithium salt. The content of the lithium salt is 10 to 70 parts by weight, for example 20 to 50 parts by weight, based on 100 parts by weight of the polymer contained in the protective film. The ionic conductivity of the protective film is very good when the content of the lithium salt is in the above range.

The lithium salt may be, for example, at least one selected from LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂.

According to the exemplary embodiment, the protective film may further include a liquid electrolyte, and the protective film may form an ion conductive path through the electrolyte.

The liquid electrolyte includes at least one selected from an organic solvent, an ionic liquid, and a lithium salt. The organic solvent includes a carbonate-based compound, a glyme-based compound, a dioxolane-based compound, dimethyl ether, 1,1,2,2-tetrafluoroethyl 2,2,3,3-tetrafluoropropyl ether, and the like. Examples of the organic solvent may include at least one selected from ethylene carbonate, propylene carbonate, dimethyl carbonate, diethyl carbonate, ethylmethyl carbonate, fluoroethylene carbonate, gamma butyrolactone, dimethoxyethane, diethoxyethane, dimethylene glycol dimethyl ether, trimethylene glycol dimethyl ether, tetraethylene glycol dimethyl ether, polyethylene glycol dimethyl ether, succinonitrile, sulfolane, dimethylsulfone, ethylmethylsulfone, diethylsulfone, adiponitrile, and 1,1,2,2-tetrafluoroethyl 2,2,3,3-tetrafluoropropyl ether.

When the protective film according to the exemplary embodiment uses a liquid electrolyte containing an organic solvent such as a carbonate compound together, the protective film is very stable against an organic solvent such as a carbonate-based compound or an electrolyte containing the same, and thus has good chemical resistance.

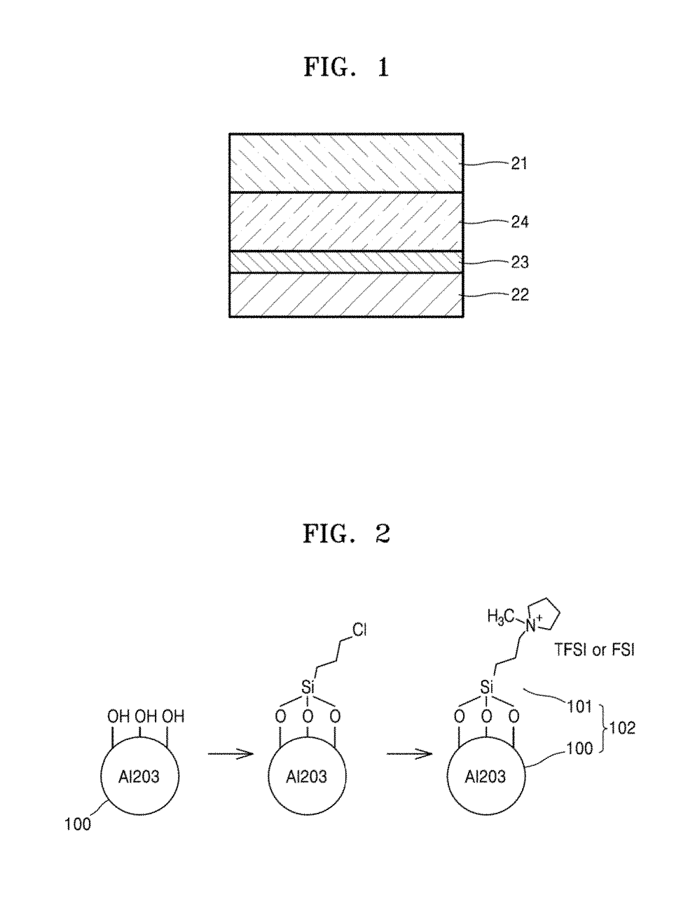

FIG. 1 illustrates a structure of a lithium metal battery according to an exemplary embodiment.

Referring to FIG. 1, a protective film 14 is disposed on a lithium metal negative electrode 11 and a liquid electrolyte 13 is disposed between the protective film 14 and a positive electrode 12. The lithium metal negative electrode 11 and the protective film 14 are collectively referred to as a protective negative electrode.

The lithium metal battery according to the exemplary embodiment may further include a separator. As the separator, polyethylene, polypropylene, polyvinylidene fluoride or a multilayer film of two or more thereof may be used, and a mixed multilayer film such as a polyethylene/polypropylene two-layer separator, a polyethylene/polypropylene/polyethylene three-layer separator, a polypropylene/polyethylene/polypropylene three-layer separator, or the like may be used. The separator may further include an electrolyte containing a lithium salt and an organic solvent.

The positive electrode may be a porous positive electrode. The porous positive electrode includes pores or a positive electrode which do not exclude the formation of positive electrode intentionally so that the liquid electrolyte may be permeated into the positive electrode by a capillary effect or the like.

For example, the porous positive electrode includes a positive electrode obtained by coating and drying a positive electrode active material composition including a positive electrode active material, a conductive agent, a binder and a solvent. The obtained positive electrode may contain pores present between the positive electrode active material particles. Such a porous positive electrode may be impregnated with a liquid electrolyte.

According to another exemplary embodiment, the positive electrode may include a liquid electrolyte, a gel electrolyte, or a solid electrolyte. The liquid electrolyte, the gel electrolyte, and the solid electrolyte may be used as the electrolyte of the lithium battery in the art, as long as the electrolytes do not deteriorate the positive electrode active material by reacting with the positive electrode active material during charging and discharging.

The lithium metal negative electrode may be a metal thin film or a lithium metal alloy thin film. The thickness of the lithium metal thin film or the lithium metal alloy thin film may be 100 μm or less. For example, the lithium battery may obtain a stable cycle characteristic even for a lithium metal thin film or a lithium metal alloy thin film having a thickness of 100 μm or less. For example, in the lithium battery, the thickness of the lithium metal thin film or the lithium metal alloy thin film may be 80 μm or less, for example, 60 μm or less, specifically 0.1 to 60 μm. When the thickness of the lithium metal thin film or the lithium metal alloy thin film is reduced to 100 μm or less in the lithium battery in the related art, the thickness of lithium deteriorated due to side reaction, formation of dendrite, or the like increases, and thus it is difficult to embody a lithium battery that provides stable cycle characteristics. However, when the protective film according to the exemplary embodiment is used, the lithium battery having stable cycle characteristics may be manufactured.

The ionic liquid refers to a salt in a liquid state at room temperature or a room-temperature molten salt, which has a melting point below room temperature and is composed of only ions. The ionic liquid may be, for example, at least one selected from the group consisting of N-methyl-N-propylpyrrolidinium bis(trifluoromethanesulfonyl)imide, N-butyl-N-methylpyrrolidium bis(3-tri fluoromethylsulfonyl)amide, 1-butyl-3-methylimidazolium bis(trifluoromethylsulfonyl)amide, and 1-ethyl-3-methylimidazolium bis(trifluoromethylsulfonyl)amide.

The content of the ionic liquid is 5 to 40 parts by weight, for example, 10 to 20 parts by weight, based on 100 parts by weight of the polymer. When the content of the ionic liquid is within the above range, a protective film having good ionic conductivity and mechanical properties may be obtained.

The oligomer is at least one selected from the group consisting of polyethylene glycol dimethyl ether and polyethylene glycol diethyl ether. The weight average molecular weight of the oligomer is 200 to 2,000, and the content of the oligomer is 5 to 50 parts by weight based on 100 parts by weight of a block copolymer. When the oligomer is added in this way, the film-forming property, the mechanical property and the ionic conductivity of the protective film are superior.

The ionic conductivity of the protective film may be 1×10⁻⁴S/cm or more at about 25° C., for example, 5×10⁻⁴ S/cm or more, specifically 1×10⁻³ S/cm or more.

Hereinafter, a method for manufacturing a lithium metal battery according to an exemplary embodiment will be described.

First, a composition for forming a protective film is obtained. An organic solvent may be added to the composition for forming the protective film. The organic solvent may be any organic solvent that may be used in the art. Examples of the organic solvent may use tetrahydrofuran, N-methylpyrrolidone, acetonitrile, benzonitrile, 2-methyltetrahydrofuran, γ-butyrolactone, dioxolane, 4-methyldioxolane, N,N-dimethylformamide, N,N-dimethylacetamide, N,N-dimethylsulfoxide, dioxane, 1,2-dimethoxyethane, sulfolane, dichloroethane, chlorobenzene, nitrobenzene, diethylene glycol, dimethyl ether or mixtures thereof. The content of the organic solvent is 100 to 3000 parts by weight based on 100 parts by weight of the polymer.

The composition for forming the protective film may further include at least one selected from a filler bound with a functional group of Formula 1 on the surface as the surface-modified filler, a polymer, at least one selected from an ionic liquid and a polymeric ionic liquid; and/or at least one selected from inorganic particles and a lithium salt.

In the case of forming the protective film using the composition for forming the protective film, the composition for forming the protective film is coated on at least a part of the lithium metal and then dried to manufacture a negative electrode for the lithium battery.

The coating method may be used as long as any method is commonly available at the time of forming the protective film. For example, methods such as spin coating, roll coating, curtain coating, extrusion, casting, screen printing, inkjet printing, doctor blading and the like may be used.

According to yet another aspect of the present disclosure, there is provided a lithium metal battery including a protective negative electrode for the lithium metal battery according to an exemplary embodiment, a positive electrode, and an electrolyte interposed therebetween.

The electrolyte may be a mixed electrolyte type by further including at least one selected from a liquid electrolyte, a solid electrolyte and a gel electrolyte. The lithium metal battery may further include a separator.

At least one selected from the liquid electrolyte, the polymeric ionic liquid, the gel electrolyte, and the solid electrolyte may be interposed between the positive electrode and the electrolyte. As described above, when at least one selected from the liquid electrolyte, the polymeric ionic liquid, the gel electrolyte, and the solid electrolyte is further included, the conductivity and the mechanical properties of the electrolyte may be further improved.

The protective film further includes a liquid electrolyte to form an ion conductive path. The liquid electrolyte further includes at least one selected from an organic solvent, an ionic liquid, and a lithium salt.

Examples of the organic solvent include a carbonate-based compound, a glyme-based compound, and a dioxolane-based compound. The carbonate-based compound includes ethylene carbonate, propylene carbonate, dimethyl carbonate, fluoroethylene carbonate, diethyl carbonate, or ethyl methyl carbonate.

The glyme-based compound is at least one selected from poly(ethylene glycol) dimethyl ether (PEGDME, polyglyme), tetra(ethylene glycol) dimethyl ether (TEGDME, tetraglyme), tri(ethylene glycol) dimethyl ether (triglyme), poly(ethylene glycol) dilaurate (PEGDL), poly(ethylene glycol) monoacrylate (PEGMA), and poly(ethylene glycol) diacrylate (PEGDA).

Examples of the dioxolane-based compound include at least one selected from the group consisting of 1,3-dioxolane, 4,5-diethyl-dioxolane, 4,5-dimethyl-dioxolane, 4-methyl-1,3-dioxolane, and 4-ethyl-1,3-dioxolane. The organic solvent includes 2,2-dimethoxy-2-phenylacetophenone, dimethyl ether (DME), 1,2-dimethoxyethane, 1,2-diethoxyethane, tetrahydrofuran, gamma butyrolactone, 1,1,2,2-tetrafluoroethyl 2,2,3,3-tetrafluoropropyl ether, and the like.

The gel electrolyte is an electrolyte having a gel form, and all gel electrolytes known in the art may be used. The gel electrolyte may contain, for example, a polymer and a polymeric ionic liquid. Here, the polymer may be, for example, a solid graft (block) copolymer electrolyte.

The solid electrolyte may be an organic solid electrolyte or an inorganic solid electrolyte.

Examples of the organic solid electrolyte include polyethylene derivatives, polyethylene oxide derivatives, polypropylene oxide derivatives, phosphate ester polymers, polyelectrolytic lysines, polyester sulfides, polyvinyl alcohols, polyvinylidene fluoride, a polymer containing an ionic dissociated group, and the like.

Examples of the inorganic solid electrolyte may include Li₃N, LiI, Li₅NI₂, Li₃N—LiI—LiOH, Li₂SiS₃, Li₄SiO₄, Li₄SiO₄—LiI—LiOH, Li₃PO₄—Li₂S—SiS₂, Cu₃N, LiPON, Li₂S.GeS2.Ga₂S₃, Li₂O.11Al₂O₃, (Na,Li)₁₊ₓTi₂₋ₓAlₓ(PO₄)₃ (0.1≤x≤0.9), Li₁₋ₓHf₂₋ₓAlₓ(PO₄)₃ (0.1≤x≤0.9), Na₃Zr₂Si₂PO₁₂, Li₃Zr₇Si₄O₁₂, Na₅TiP₃O₁₂, Na₅TiP₃O₁₂, Na₃Fe₂P₃O₁₇, Na₄NbP₃O₁₂, Na-Silicates, Li_{0.3}La_{0.5}TiO₃, Na₅MSi₄O₁₂ (M is a rare earth element such as Nd, Gd and Dy) Li₅ZrP₃O₁₂, Li₅TiP₃O₁₂, Li₃Fe₂P₃O₁₇, Li₄NbP₃O₁₇, Li₁₊ₓ(M,Al,Ga)ₓ(Ge_{1-y}Ti_{y})₂₋ₓ(PO₄)₃(X≤0.8, 0≤Y≤1.0, M is Nd, Sm, Eu, Gd, Tb, Dy, Ho, Er, Tm or Yb), Li_{1+x+y}QₓTi₂₋ₓSi_{y}P_{3+y}O₁₂ (0<x≤0.4, 0<y≤0.6, Q is Al or Ga), Li₆BaLa₂Ta₂O₁₂, Li₇La₃Zr₂O₁₂, Li₅La₃Nb₇O₁₂, Li₅La₃M₂O₁₂ (M is Nb, or Ta), and Li₇₊ₓAₓLa₃₋ₓZr₂O₁₂) (0<x<3, A is Zn).

The lithium metal negative electrode may be a lithium metal thin film electrode or a lithium metal alloy electrode, and a liquid electrolyte containing at least one selected from an organic solvent, an ionic liquid and a lithium salt may be further included between the electrolyte and the positive electrode.

The lithium metal battery has been widely used in fields such as cell phones, notebook computers, batteries for power generation facilities such as wind power and solar power, electric vehicles, uninterruptible power supply devices, and household batteries due to high voltage, capacity and energy density.

The lithium metal battery according to the exemplary embodiment may have an operating voltage of 4.0 to 5.0 V, for example, 4.5 to 5.0 V.

Respective components of the lithium metal battery including the protective negative electrode according to the exemplary embodiment and the method for manufacturing the lithium metal battery having the components will be described below in more detail.

The positive electrode active material for manufacturing the positive electrode may include at least one selected from the group consisting of lithium cobalt oxide, lithium nickel cobalt manganese oxide, lithium nickel cobalt aluminum oxide, lithium iron phosphate oxide, and lithium manganese oxide, but is not limited thereto and all positive electrode active materials available in the art may be used.

For example, the positive electrode active material may use a compound represented by any one of Chemical Formulas of LiₐA_{1-b}B_{b}D₂ (in the above formula, 0.90≤a≤1.8, and 0≤b≤0.5); LiₐE_{1-b}B_{b}O_{2-c}D_{c} (in the above formula, 0.90≤a≤1.8, 0≤b≤0.5, and 0≤c≤0.05); LiE_{2-b}B_{b}O_{4-c}D_{c} (in the above formula, 0≤b≤0.5, and 0≤c≤0.05); LiₐNi_{1-b-c}Co_{b}B_{c}D_{α} (in the above formula, 0.90≤a≤1.8, 0≤b≤0.5, 0≤c≤0.05, and 0<α≤2); LiₐNi_{1-b-c}Co_{b}B_{c}O_{2-α}F_{α} (in the above formula, 0.90≤a≤1.8, 0≤b≤0.5, 0≤c≤0.05, and 0<α<2); LiₐNi_{1-b-c}Co_{b}B_{c}O_{2-α}F_{α} (in the above formula, 0.90≤a≤1.8, 0≤b≤0.5, 0≤c≤0.05, and 0<α<2); LiₐNi_{1-b-c}Mn_{b}B_{c}O_{2-α}F_{α} (in the above formula, 0.90≤a≤1.8, 0≤b≤0.5, 0≤c≤0.05, and 0<α≤2); LiₐNi_{1-b-c}Mn_{b}B_{c}O_{2-α}Fₐ (in the above formula, 0.90≤a≤1.8, 0≤b≤0.5, 0≤c≤0.05, and 0<α<2); LiₐNi_{1-b-c}Mn_{b}B_{c}O_{2-α}F_{α} (in the above formula, 0≤b≤0.5, 0≤c≤0.05, and 0≤α≤2); LiₐNi_{b}E_{c}G_{d}O₂ (in the above formula, 0.90≤a≤1.8, 0≤b≤0.9, 0≤c≤0.5, and 0.001≤d≤0.1); LiₐNi_{b}Co_{c}Mn_{d}GeO₂ (in the above formula, 0.90≤a≤1.8, 0≤b≤0.9, 0≤c≤0.5, 0≤d≤0.5, and 0.001≤e≤0.1); LiₐNiG_{b}O₂ (in the above formula, 0.90≤a≤18, and 0.001≤b≤0.1); LiₐCoG_{b}O₂ (in the above formula, 0.90≤a≤1.8, and 0.001≤b≤0.1); LiₐMnG_{b}O₂ (in the above formula, 0.90≤a≤1.8, and 0.001≤b≤0.1); LiₐMn₂G_{b}O₄ (in the above formula, 0.90≤a≤1.8, and 0.001≤b≤0.1); QO₂; QS₂; LiQS₂; V₂O₅; LiV₂O₅; LiIO₂; LiNiVO₄; Li_{(3-f)}J₂(PO₄)₃(0≤f≤2); Lio_{(3-f)}Fe₂(PO₄)₃(0≤f≤2); and LiFePO₄.

In Chemical Formulas above, A is Ni, Co, Mn, or a combination thereof; B is Al, Ni, Co, Mn, Cr, Fe, Mg, Sr, V, a rare earth element or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

The positive electrode is prepared according to the following method.

A positive electrode active material composition in which a positive electrode active material, a binder and a solvent are mixed is prepared.

A conductive agent may further be added to the positive electrode active material composition.

The positive electrode active material composition is directly coated on a metal current collector and dried to manufacture a positive electrode plate. Alternatively, the positive electrode active material composition is cast on a separate support, and then a film released from the support is laminated on the metal current collector to manufacture a positive electrode plate.

The binder is added in an amount of 1 to 50 parts by weight based on 100 parts by weight of the total weight of the positive electrode active material, which is a component for assisting binding between the active material and the conductive agent and binding to the current collector. Non-limiting examples of such a binder may include polyvinylidene fluoride, polyvinyl alcohol, carboxymethylcellulose (CMC), starch, hydroxypropylcellulose, regenerated cellulose, polyvinylpyrrolidone, tetrafluoroethylene, polyethylene, polypropylene, ethylene-propylene-diene terpolymer (EPDM), sulfonated EPDM, styrene butylene rubber, fluorine rubber, various copolymers, and the like. The content thereof is 2 to 5 parts by weight based on 100 parts by weight of the total weight of the positive electrode active material. When the content of the binder is in the above range, the binding force of the active material layer to the current collector is good.

The conductive agent is not particularly limited as long as any conductive agent has conductivity without causing a chemical change in the battery, and may use, for example, graphite such as natural graphite or artificial graphite; carbonaceous materials such as carbon black, acetylene black, ketjen black, channel black, furnace black, lamp black, and summer black; conductive fibers such as carbon fiber and metal fiber; metal powders such as carbon fluoride, aluminum and nickel powder; conductive whiskey such as zinc oxide and potassium titanate; conductive metal oxides such as titanium oxide; conductive materials such as polyphenylene derivatives, and the like.

The content of the conductive agent is 1 to 10 parts by weight, for example, 2 to 5 parts by weight based on 100 parts by weight of the total weight of the positive electrode active material. When the content of the conductive agent is in the above range, the conductivity of the finally obtained electrode is good.

As a non-limiting example of the solvent, N-methylpyrrolidone and the like are used.

The content of the solvent is 100 to 2000 parts by weight based on 100 parts by weight of the positive electrode active material. When the content of the solvent is within the above range, an operation for forming the active material layer is easy.

The negative electrode may be a lithium metal thin film or a lithium alloy thin film as described above.

The lithium alloy may include lithium and a metal/metalloid capable of alloying with lithium. For example, the metal/metalloid capable of alloying with lithium may be Si, Sn, Al, Ge, Pb, Bi, Sb, a Si—Y alloy (Y is an alkali metal, an alkali earth metal, a Group 13 element, a Group 14 element, a transition metal, a rare earth element, or a combination element thereof, and not Si), a Sn—Y alloy (Y is an alkali metal, an alkali earth metal, a Group 13 element, a Group 14 element, a transition metal, a rare earth element, or a combination element thereof, and not Sn), and the like. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or combinations thereof.

As the electrolyte, a separator and/or a lithium salt-containing nonaqueous electrolyte commonly used in a lithium battery may be used.

The separator uses an insulating thin film having high ion permeability and mechanical strength. The pore diameter of the separator is generally 0.01 to 10 μm, and the thickness is generally 5 to 20 μm. As such a separator, for example, an olefin-based polymer such as polypropylene; a sheet or nonwoven fabric made of glass fiber, polyethylene or the like is used. When a solid polymer electrolyte is used as the electrolyte, the solid polymer electrolyte may also serve as the separator.

Specific examples of the separator may include polyethylene, polypropylene, polyvinylidene fluoride, or a multilayer film of two or more thereof may be used, and may include a mixed multilayer film such as a polyethylene/polypropylene two-layer separator, a polyethylene/polypropylene/polyethylene three-layer separator, a polypropylene/polyethylene/polypropylene three-layer separator, or the like.

The lithium salt-containing nonaqueous electrolyte is made of a non-aqueous electrolyte and a lithium salt.

As the non-aqueous electrolyte, a non-aqueous electrolyte, an organic solid electrolyte, or an inorganic solid electrolyte is used.

The non-aqueous electrolyte includes an organic solvent. The organic solvent may include all organic solvents that may be used in the art. For example, the organic solvent includes propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, fluoroethylene carbonate, benzonitrile, acetonitrile, tetrahydrofuran, 2-methyl tetrahydrofuran, γ-butyrolactone, dioxolane, 4-methyl dioxolane, N,N-dimethylformamide, N,N-dimethylacetamide, dimethylsulfoxide, dioxane, 1,2-dimethoxyethane, sulfolane, dichloroethane, chlorobenzene, nitrobenzene, diethylene glycol, dimethyl ether or mixtures thereof. Examples of the lithium salt include LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (however, x and y are natural numbers), LiCl, LiI or mixtures thereof. For the purpose of improving charge/discharge characteristics, flame retardancy, and the like, in the non-aqueous electrolyte, pyridine, triethylphosphite, triethanolamine, cyclic ether, ethylenediamine, glyme, hexamethyl phosphoramide, nitrobenzene derivative, sulfur, quinone imine dye, N-substituted oxazolidinone, N,N-substituted imidazolidine, ethylene glycol dialkyl ether, ammonium salt, pyrrole, 2-methoxyethanol, aluminum trichloride, and the like may also be added. In some cases, a halogen-containing solvent such as carbon tetrachloride or ethylene trifluoride may be further included to apply nonflammability.

The lithium battery according to the exemplary embodiment may be used for not only a battery cell used as a power source for a small-sized device but also a unit cell in a medium/large-sized battery pack or battery module including a plurality of battery cells used as a power source for a medium/large-sized device due to good capacity and lifetime characteristics.

Examples of the medium/large-sized device may include electric vehicles including an electric vehicle (EV), a hybrid electric vehicle (HEV), a plug-in hybrid electric vehicle (PHEV), electric two-wheeled vehicles including an E-bike and an electric scooter, an electric power tool electric power storage device, and the like, but the present disclosure is not limited thereto.

In this specification, alkyl refers to fully saturated branched or unbranched (alternatively, straight-chain or linear) hydrocarbon.

Non-limiting examples of “alkyl” may include methyl, ethyl, n-propyl, isopropyl, n-butyl, isobutyl, sec-butyl, n-pentyl, isopentyl, neopentyl, iso-amyl, n-hexyl, 3-methylhexyl, 2,2-dimethylpentyl, 2,3-dimethylpentyl, n-heptyl and the like.

One or more hydrogen atoms of the “alkyl” may be substituted with a halogen atom, a C1-C20 alkyl group (e.g., CCF₃, CHCF₂, CH₂F, CCl₃, etc.) substituted with a halogen atom, a C1-C20 alkoxy group, a C2-C20 alkoxyalkyl group, a hydroxyl group, a nitro group, a cyano group, an amino group, an amidino group, hydrazine, hydrazone, a carboxyl group or a salt thereof, a sulfonyl group, a sulfamoyl group, a sulfonic acid group or a salt thereof, a phosphoric acid or a salt thereof, a C1-C20 alkyl group, a C2-C20 alkenyl group, a C2-C20 alkynyl group, a C1-C20 heteroalkyl group, a C6-C20 aryl group, a C6-C20 arylalkyl group, a C6-C20 heteroaryl group, a C7-C20 heteroarylalkyl group, a C6-C20 heteroaryloxy alkyl group, or a C6-C20 heteroarylalkyl group.

The term “halogen atom” includes fluorine, bromine, chlorine, iodine and the like.

“Alkenyl” refers to branched or unbranched hydrocarbons having at least one carbon-carbon double bond. Non-limiting examples of the alkenyl group include vinyl, allyl, butenyl, isopropenyl, isobutenyl, and the like, and at least one hydrogen atom of the alkenyl may be substituted with the same substituent as the alkyl group described above.

“Alkynyl” refers to branched or unbranched hydrocarbons having at least one carbon-carbon triple bond. Non-limiting examples of the “alkynyl” may include ethynyl, butynyl, isobutynyl, isopropynyl, and the like.

At least one hydrogen atom of “alkynyl” may be substituted with the same substituent as the alkyl group described above.

“Aryl” also includes a group in which an aromatic ring is fused to one or more carbon rings. Non-limiting examples of “aryl” include phenyl, naphthyl, tetrahydronaphthyl, and the like.

Also, at least one hydrogen atom in the “aryl” group may be substituted with the same substituent as the alkyl group described above.

“Heteroaryl” means monocyclic or bicyclic organic compounds containing one or more heteroatoms selected from N, O, P or S and the remaining ring atoms of carbons. The heteroaryl group may contain, for example, 1 to 5 hetero atoms, and may include 5-10 ring members. The S or N may be oxidized to have various oxidation states.

Examples of heteroaryl may include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl group, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isooxazol-3-yl, isooxazol-4-yl, isooxazol-5-yl, 1,2,4-triazol-3-yl, 1,2,4-triazol-5-yl, 1,2,3-triazol-4-yl, 1,2,3-triazol-5-yl, tetrazolyl, pyride-2-yl, pyride-3-yl, 2-pyrazin-2-yl, pyrazin-4-yl, pyrazin-5-yl, 2-pyrimidin-2-yl, 4-pyrimidin-2-yl, or 5-pyrimidin-2-yl.

The term “heteroaryl” includes those where a heteroaromatic ring is fused to at least one aryl, cycloaliphatic, or heterocycle.

The “carbon ring” group used in Formula refers to a saturated or partially unsaturated non-aromatic monocyclic, bicyclic or tricyclic hydrocarbon group.

Examples of the monocyclic hydrocarbon include cyclopentyl, cyclopentenyl, cyclohexyl, cyclohexenyl, and the like. Examples of the bicyclic hydrocarbon include bornyl, decahydronaphthyl, bicyclo[2.1.1]hexyl, bicyclo[2.2.1]heptyl, bicyclo[2.2.1]heptenyl, or bicyclo[2.2.2]octyl. Examples of the tricyclic hydrocarbon include adamantly and the like.

“Heterocycle” is a cyclic hydrocarbon containing at least one heteroatom and may contain 5 to 20, for example, 5 to 1 carbon atoms. Here, the heteroatom is one selected from sulfur, nitrogen, oxygen and boron.

Alkoxy, aryloxy, and heteroaryloxy means alkyl, aryl, and heteroaryl bound to oxygen atoms in this specification, respectively.

The present disclosure will be described in more detail through the following Examples and Comparative Examples. However, Examples are for illustrative purposes only and are not limited thereto.

### Preparation Example 1: Preparation of Filler

200 mg of aluminum oxide (Al₂O₃) was mixed with 1 mL of chloroethylsilane and 10 g of toluene as a solvent and reacted at about 105° C. for 1200 minutes to prepare surface-modified aluminum oxide as illustrated in FIG. 2. Subsequently, the surface-modified aluminum oxide reacted with 500 mg of N-methylpyrrolidine as a quaternary ammonium compound in dichloroethane (DCE) at 70° C. for 540 minutes to prepare a surface-modified filler represented by Formula 12.

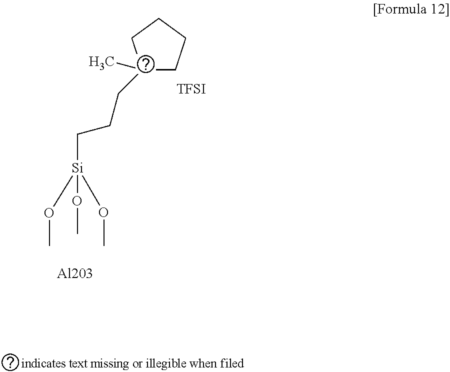

In Formula 12, TFSI represents trifluoromethylsulfonyl imide.

### Example 1: Manufacture of Lithium Metal Battery (Full Cell)

4.76 parts by weight of a vinylidene fluoride-hexafluoropropylene (VdF-HFP) copolymer (VdF-HFP molar ratio of 88:12), 4.76 parts by weight of a filler of Formula 12 prepared according to Preparation Example 1, and 85 parts by weight of N-methyl pyrrolidine(NMP) as a solvent were mixed to obtain a composition for forming a protective film.

The composition for forming the protective film was coated on a lithium metal thin film (thickness: about 20 vim) to a thickness of about 5 vim with a doctor blade. The coated product was dried at about 25° C. and then heat treated at about 40° C. under vacuum to manufacture a lithium negative electrode having a protective film disposed on a lithium metal.

Separately, a positive electrode composition was obtained by mixing LiCoO₂, a conductive agent (Super-P; Timcal Ltd.), polyvinylidene fluoride (PVdF) and N-pyrrolidone. The mixing weight ratio of LiCoO₂, the conductive agent and PVDF in the positive electrode composition was 97:1.5:1.5.

The positive electrode composition was coated on an aluminum foil (thickness: about 15 μm), dried at 25° C., and then the dried product was dried at about 110° C. under vacuum to manufacture a positive electrode.

A lithium metal battery (coin cell) was manufactured by interposing a polyethylene/polypropylene separator between the positive electrode obtained by the above process and a lithium metal negative electrode (thickness: about 20 μm). Here, a liquid electrolyte was added between the positive electrode and the negative electrode. As the liquid electrolyte, an electrolytic solution in which 0.8 M LiFSI was dissolved in a mixed solvent of dimethyl ether (DME) and 1,1,2,2-tetrafluoroethyl 2,2,3,3-tetrafluoropropyl ether (TPE-TTE) in a volume ratio of 16:84 was used.

### Example 2: Manufacture of Lithium Metal Battery (Half Cell)

A lithium metal battery (half cell) was manufactured in the same manner as in Example 1, except that a lithium metal electrode was used as the positive electrode instead of the positive electrode manufactured according to Example 1.

### Examples 3-4: Manufacture of Lithium Metal Battery (Full Cell)

A lithium metal battery (full cell) was manufactured in the same manner as in Example 1, except that the thickness of the protective film was controlled to be about 1 μm and 3 μm, respectively.

### Examples 5-6: Manufacture of Lithium Metal Battery (Full Cell)

A lithium metal battery (full cell) was manufactured in the same manner as in Example 1, except that the content of the filler in Formula 12 was changed to 1 part by weight and 150 parts by weight, respectively.

### Comparative Example 1: Manufacture of Lithium Metal Battery (Full Cell)

A lithium metal battery (full cell) was manufactured in the same manner as in Example 1, except that no filler was used in the preparation of the protective film.

### Comparative Example 2: Manufacture of Lithium Metal Battery (Half Cell)

A lithium metal battery (full cell) was manufactured in the same manner as in Example 2, except that no filler was used in the preparation of the protective film.

### Comparative Example 3: Cell of Lithium Metal Battery (Full Cell)

A lithium metal battery (full cell) was manufactured in the same manner as in Example 1, except that aluminum oxide (Al₂O₃) was used as a filler.

### Comparative Example 4: Cell of Lithium Metal Battery (Full Cell)

A lithium metal battery (full cell) was manufactured in the same manner as in Comparative Example 3, except that no filler was used in the preparation of the protective film.

### Comparative Example 5: Cell of Lithium Metal Battery (Full Cell)

A lithium metal battery (full cell) was manufactured in the same manner as in Example 1, except that aluminum oxide surface-treated with 3-aminopropyltriethoxysilane as a silane compound was used as a filler.

### Evaluation Example 1: Scanning Electron Microscope (SEM)

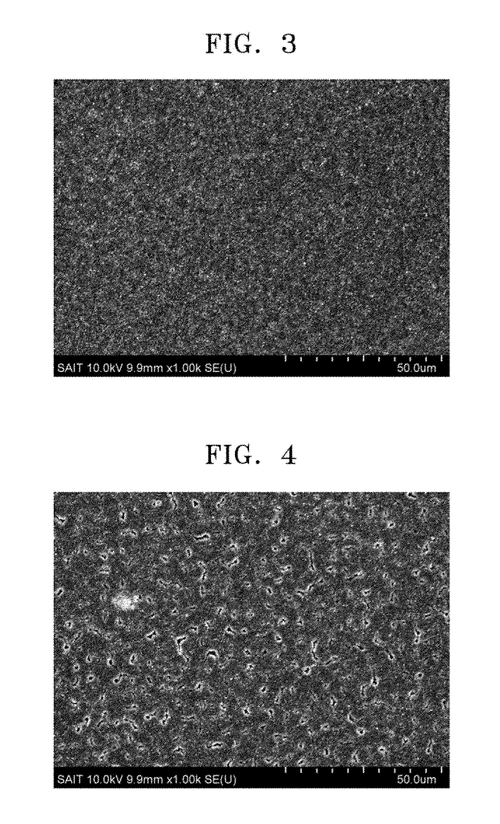

The state of a protective film disposed on the surface of a lithium metal electrode according to Example 1 and Comparative Example 3 was analyzed using a scanning electron microscope. The analyzed results were illustrated in FIGS. 3 and 4.

Referring to FIGS. 3 and 4, it may be seen that the uniformity of the film is improved due to the surface modification of the protective film according to Example 1. In contrast, in Comparative Example 3 using the unmodified filler, it might be seen that cracks were present in the protective film. When the cracks were formed in the protective film, the probability of occurrence of lithium dendrite was high at this portion.

### Evaluation Example 2: Electrodeposition Density

The lithium metal batteries manufactured according to Example 1 and Comparative Examples 1 and 3-4 were subjected to constant current charging until the voltage reached 4.30 V (vs. Li) at a current of 0.1 C rate at 25° C., and then the electrodeposition density on a lithium surface was examined.

The evaluation results of the electrodeposition density were illustrated in Table 1 below.

TABLE 1

| Classification | Electrodeposition density (g/cc) |
|---|---|
| Example 1 | 0.233 |
| Comparative Example 1 | 0.103 |
| Comparative Example 3 | 0.168 |
| Comparative Example 4 | 0.125 |

Referring to Table 1, the electrodeposition density of the lithium metal battery manufactured according to Example 1 was increased as compared with those of the lithium metal batteries manufactured according to Comparative Examples 1, 3, and 4. From this, it may be seen that the lithium metal battery manufactured according to Example 1 has a lithium dendrite suppression function better than those of Comparative Examples 1, 3 and 4.

### Evaluation Example 3: Measurement of Impedance

With respect to the lithium metal battery manufactured according to Example 1 and the lithium metal batteries manufactured according to Comparative Examples 1, 3 and 4, the resistance at 25° C. was measured according to a 2-probe method using an impedance analyzer (Solartron 1260A Impedance/Gain-Phase Analyzer). The amplitude was ±10 mV, and the frequency range was 0.1 Hz to 1 MHz.

The evaluation results of the impedance were illustrated in Table 2 below.

TABLE 2

| Classification | Impedance (Ω) |
|---|---|
| Example 1 | 4.6 |
| Comparative Example 1 | 3.46 |
| Comparative Example 3 | 5.75 |
| Comparative Example 4 | 3.75 |

As illustrated in Table 2, the lithium metal battery manufactured according to Example 1 exhibited larger impedance than those of Comparative Examples 1 and 4 without using the filler. As a result, when using the surface-modified filler as in Example 1, the dispersibility of the filler in the protective film was improved and the impedance characteristic was improved as compared with the case (Comparative Example 3) where the unmodified filler was used.

On the other hand, in the lithium metal batteries manufactured according to Examples 1 and 3-5, the change in impedance according to the thickness of the protective film was examined.

The impedance measurement results were shown in Table 3.

TABLE 3

| Classification | Thickness of protective film (μm) | Impedance (Ω) |
|---|---|---|
| Example 1 | 5 | 4.6 |
| Example 3 | 1 | 3.95 |
| Example 4 | 3 | 4.6 |

Referring to Table 3, it might be seen that the resistance value increased as the thickness of the protective film increased.

### Evaluation Example 4: Charge and Discharge Characteristics (Discharge Capacity)

### 1) Example 1 and Comparative Examples 1, 3, 4, and 5

The lithium metal battery (full cell) manufactured according to Example 1 and the lithium metal batteries (full cell) manufactured according to Comparative Examples 1, 3, 4, and 5 (full cells) were subjected to constant current charging until the voltage reached 4.40 V (vs. Li) at a current of 0.1 C rate at 25° C., and then cut off at a current of 0.05 C rate while maintaining 4.40 V in a constant voltage mode. After a pause period of 10 minutes, the lithium metal batteries were discharged at a constant current of 1.0 C rate until the voltage reached 3.0 V (vs. Li) during the discharge (formation step, 1st cycle). This charging and discharging process was performed two times to complete the formation step.

The lithium metal battery subjected to the formation step was charged at a constant current of 1 C in a voltage range of 3.0 to 4.4 V compared with lithium metal at room temperature (25° C.) and then discharged at a constant current of 0.72 mA until reaching a cut-off voltage of 4.4 V at 0.2 C.

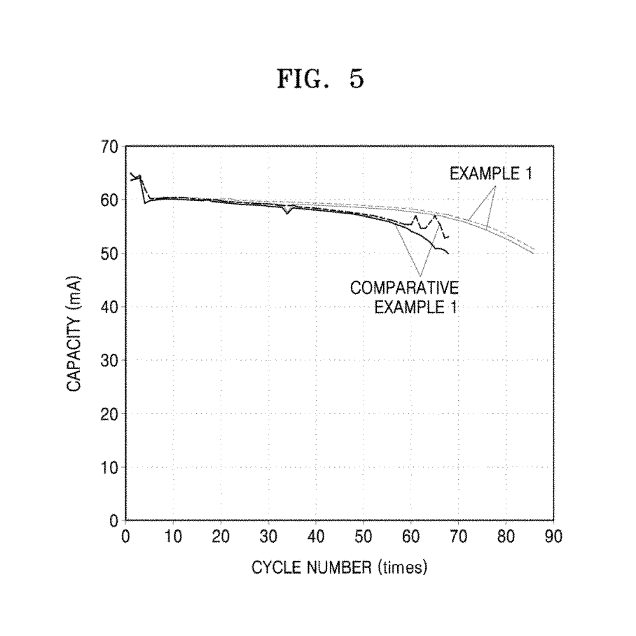

The charging and discharging process described above was repeatedly performed, and the lifetime was examined and illustrated in Table 4 below. The lifetime is the number of cycles in which the discharge capacity is reduced to 80% of the discharge capacity in one cycle. The lifetime characteristics in the lithium metal battery manufactured in Example 1 were illustrated in FIG. 4 and the lifetime characteristics in the lithium metal batteries manufactured in Comparative Example 1 were illustrated in FIG. 5.

TABLE 4

| Classification | Lifetime (@ 80%) |
|---|---|
| Example 1 | 83 |
| Comparative Example 1 | 68 |
| Comparative Example 3 | 57 |
| Comparative Example 4 | 63 |

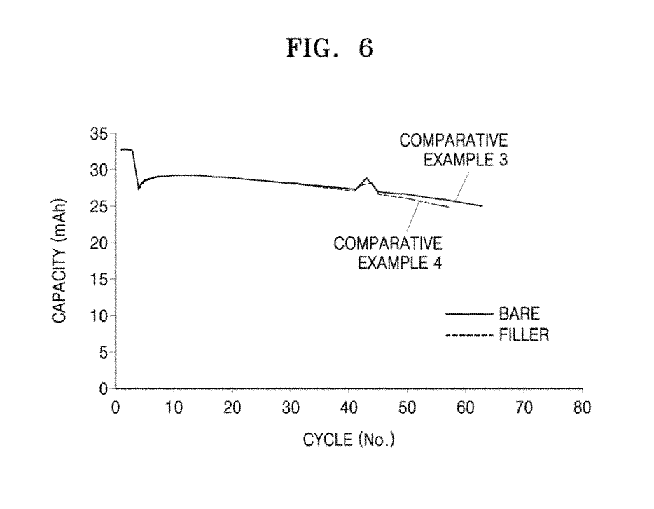

From Table 4 and FIGS. 5 and 6, it may be seen that the lifetime of the lithium metal battery manufactured according to Example 1 is much improved as compared with those of the lithium metal batteries manufactured according to Comparative Examples 1, 3, and 4.

In addition, the lithium metal battery manufactured according to Comparative Example 5 was performed in the same manner as Comparative Example 3 and the lifetime was evaluated.

As a result of the evaluation, the lithium metal battery manufactured according to Comparative Example 5 exhibited a lifetime characteristic equivalent to that of Comparative Example 3.

### 2) Examples 5-6

The lifetime of the lithium metal batteries manufactured in Examples 5-6 was evaluated in the same manner as a lifetime evaluation method of the full cells manufactured according to Example 1 and Comparative Examples 1, 3 and 4.

As a result of the evaluation, the lithium metal batteries manufactured according to Examples 5-6 exhibited a lifetime characteristic equivalent to that of Example 1.

### 3) Example 2 and Comparative Example 2

The lifetime of the half cells manufactured in Example 2 and Comparative Example 2 was evaluated in the same manner as a lifetime evaluation method of the full cells manufactured according to Example 1 and Comparative Examples 1, 3 and 4, and the results were illustrated in Table 5 below.

TABLE 5

| Classification | Lifetime (@ 80%) |
|---|---|
| Example 2 | 65 |
| Comparative Example 2 | 45 |

Referring to Table 5, the half cell manufactured according to Example 2 has an improved lifetime characteristic as compared with that of Comparative Example 2.

### Evaluation Example 5: Voltage Profile

The lithium metal battery (half cell) manufactured according to Example 2 was charged at a constant current until the voltage reached 4.40 V (vs. Li) at a current of 1.0 C rate at 25° C. and then cut-off at a current of 0.05 C rate while being maintained at 4.40 V in a constant voltage mode. After a pause period of 10 minutes, the lithium metal battery was discharged at a constant current of 1.0 C rate until the voltage reached 3.0 V (vs. Li) during the discharge (formation step, 1st cycle). This charging and discharging process was performed two times to complete the formation step.

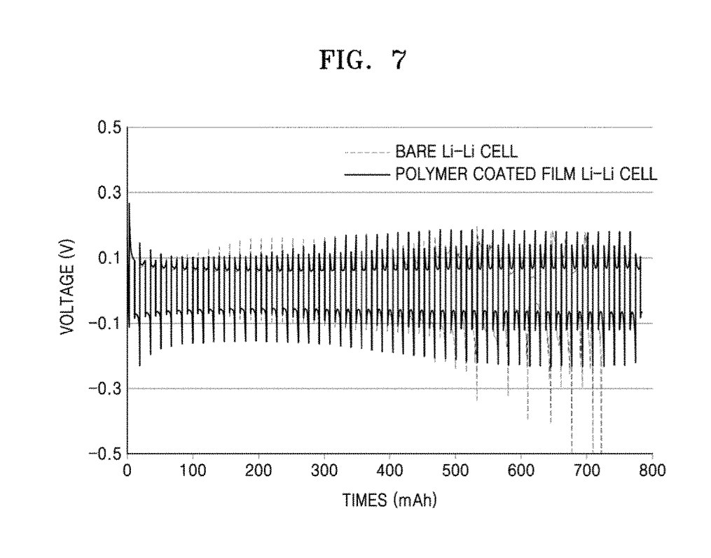

The lithium metal battery subjected to the formation step was charged at a constant current of 1 C in a voltage range of 3.0 to 4.4 V compared with lithium metal at room temperature (25° C.) and then discharged at a constant current of 0.72 mA until reaching a cut-off voltage of 3.0 V at 1 C. The voltage profile was examined and illustrated in FIG. 7.

As illustrated in FIG. 7, it may be seen that the lithium metal battery manufactured according to Example 2 has improved discharge voltage characteristics even after a lapse of time.

While the exemplary embodiments have been described with reference to the drawings and Examples, but are just for illustrative. It will be apparent to those skilled in the art that various modifications and equivalences are possible. Therefore, the scope of the present disclosure should be determined by the appended claims.

### INDUSTRIAL APPLICABILITY

By using the lithium negative electrode protective film for the lithium metal battery according to an exemplary embodiment, it is possible to effectively inhibit the growth of lithium dendrite on the surface of the lithium metal negative electrode and increase the lithium electrodeposition density. As a result, it is possible to manufacture a lithium metal battery with an improved life span.

1. A protective negative electrode for a lithium metal battery, comprising:
a lithium metal negative electrode; and
a protective film disposed on the lithium metal negative electrode and including a filler bound with a functional group represented by the following Formula 1 and a polymer: 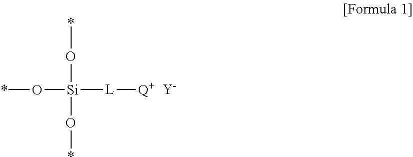
wherein, in Formula 1,
L is a substituted or unsubstituted C1 to C10 alkyl group,
Q⁺ is a quaternary ammonium cation,
Y⁻ is a monovalent anion, and
represents a site where the functional group of Formula 1 is bound to a surface of the filler.

2. The protective negative electrode for a lithium metal battery of claim 1, wherein the Q⁺ is —N⁺(R₁)(R₂)(R₃)(R₄),
R₁, R₂, R₃ and R₄ each independently represent a substituted or unsubstituted C1 to C10 alkyl group or a substituted or unsubstituted C6 to C10 aryl group, and at least two of R₁, R₂, R₃ and R₄ are bound to each other to form a ring, and
the Y is PF₆, BF₄, SbF₆, AsF₆, ClO₄, CF₃SO₃, (CF₃SO₂)₂N, C₄F₉SO₃, AlO₂, AlCl₄, (NC)N, PF₃(CF₂CF₃)₃, (FSO₂)₂N, (CF₃SO₂)₂N, (C₂F₅SO₂)₂N, (C₂F₅SO₂)(CF₃SO₂)N or (FSO₂)(CF₃SO₂)N.

3. The protective negative electrode for a lithium metal battery of claim 1, wherein the -L-Q⁺Y⁻ is at least one selected from the group consisting of the following Chemical Formulas 2 to 8, 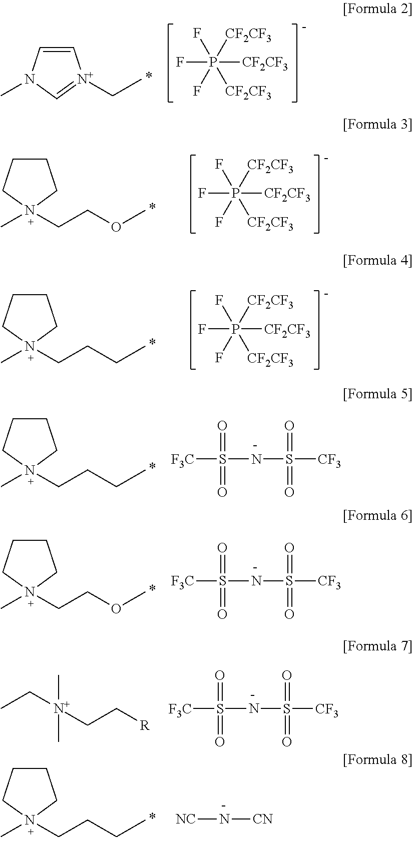
in Chemical Formulas 2 to 8 above, * represents a site bound to Si.

4. The protective negative electrode for a lithium metal battery of claim 1, wherein the filler bound with the functional group represented by Formula 1 is at least one selected from SiO₂, TiO₂, ZnO, Al₂O₃, BaTiO₃, and silsesquioxane having a cage structure to which the functional group represented by Formula 1 is bound.

5. The protective negative electrode for a lithium metal battery of claim 1, wherein the filler bound with the functional group represented by Formula 1 has a structure in which a filler of at least one selected from SiO₂, TiO₂, ZnO, Al₂O₃, BaTiO₃, and silsesquioxane having a cage structure and at least one selected from functional groups represented by functional groups represented by the following Chemical Formulas 9 to 11 are bound to the surface of the filler: 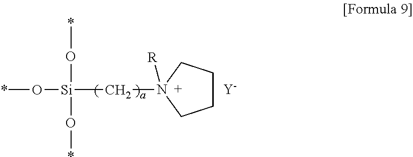
wherein, in Formula 9, a is an integer of 1 to 5,
R is hydrogen or a C1-C5 alkyl group, and
Y is PF₆, BF₄, SbF₆, AsF₆, ClO₄, CF₃SO₃, (CF₃SO₂)₂N, C₄F₉SO₃, AlO₂, AlCl₄, (NC)N, PF₃(CF₂CF₃)₃, (FSO₂)₂N, (CF₃SO₂)₂N, (C₂F₅SO₂)₂N, (C₂F₅SO₂)(CF₃SO₂)N, or (FSO₂)(CF₃SO₂)N, 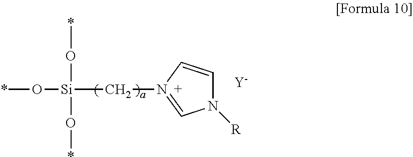
in Formula 10, a is an integer of 1 to 5,
R is hydrogen or a C1-C5 alkyl group, and
Y is PF₆, BF₄, SbF₆, AsF₆, ClO₄, CF₃SO₃, (CF₃SO₂)₂N, C₄F₉SO₃, AlO₂, AlCl₄, (NC)N, PF₃(CF₂CF₃)₃, (FSO₂)₂N, (CF₃SO₂)₂N, (C₂F₅SO₂)₂N, (C₂F₅SO₂)(CF₃SO₂)N, or (FSO₂)(CF₃SO₂)N, 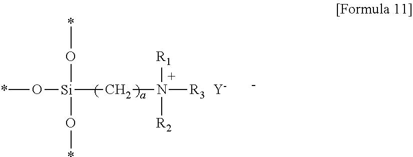
In Formula 11, a is an integer of 1 to 5,
Y is PF₆, BF₄, SbF₆, AsF₆, ClO₄, CF₃SO₃, (CF₃SO₂)₂N, C₄F₉SO₃, AlO₂, AlCl₄, (NC)N, PF₃(CF₂CF₃)₃, (FSO₂)₂N, (CF₃SO₂)₂N, (C₂F₅SO₂)₂N, (C₂F₅SO₂)(CF₃SO₂)N, or (FSO₂)(CF₃SO₂)N,
R₁ to R₃ are each independently hydrogen or a C1 to C10 alkyl group, and
represents a site where the functional group of Formula 1 is bound to the surface of the filler.

6. The protective negative electrode for a lithium metal battery of claim 1, wherein in the filler bound with the functional group represented by Formula 1, at least one selected from functional groups represented by the following Chemical Formulas is bound to SiO₂, or TiO₂ and the surface of SiO₂ or TiO₂: 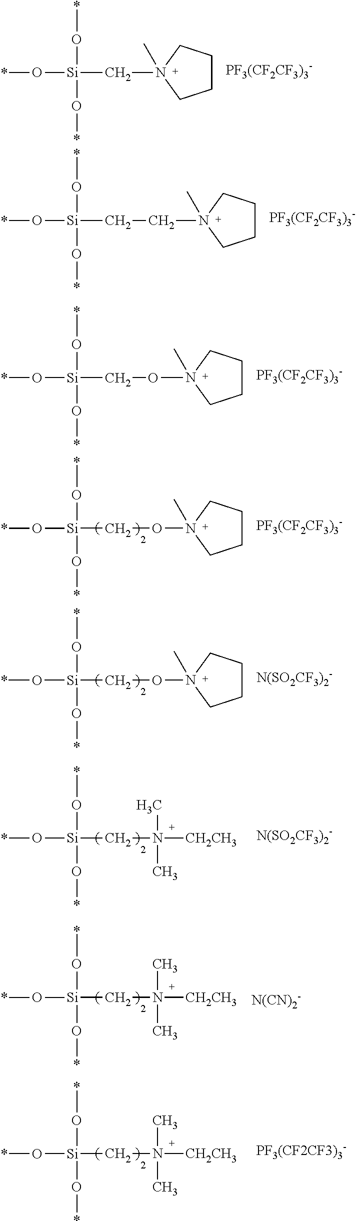
wherein, in the chemical formulas, * represents a site where the functional group of Formula 1 is bound to the surface of the filler.

7. The protective negative electrode for a lithium metal battery of claim 1, wherein the polymer is at least one selected from a vinylidene fluoride-hexafluoropropylene copolymer, polyvinylidene fluoride, polymethylmethacrylate, carboxymethylcellulose, styrene-butadiene rubber, polyacrylonitrile, and polytetrafluoro ethylene.

8. The protective negative electrode for a lithium metal battery of claim 1, wherein a content of the filler is 1 to 150 parts by weight based on 100 parts by weight of the polymer.

9. The protective negative electrode for a lithium metal battery of claim 1, wherein a thickness of the protective film is 1 to 20 μm.

10. A lithium metal battery comprising:
a positive electrode;
the protective negative electrode of claim 1; and
an electrolyte interposed therebetween.

11. The lithium metal battery of claim 10, wherein an electrodeposition density on a surface of the lithium metal electrode of the protective negative electrode is 0.2 to 0.3 g/cc.
